(19) United States
(12) Patent Application Publication
(10) Pub. No.: US 2007/0017638 A1
(43) Pub. Date: Jan. 25, 2007

(54) Device for applying adhesive to a substrate

(75) Inventor: Andre Moebius, Zurich (CH)

Correspondence Address: THELEN REID & PRIEST, LLP, P. O. BOX 640640, SAN JOSE, CA, 95164-0640, US

(73) Assignee: Unaxis International Trading Ltd. a Swiss Corporation

(21) Appl. No.: 11/493,278

(22) Filed: Jul. 25, 2006

(30) Foreign Application Priority Data
Jul. 25, 2005 (CH) 1236/05

(51) Int. Cl. G05G 15/00

(52) U.S. Cl. 156/352

(57) ABSTRACT

A device for applying adhesive to a substrate from a liquid container containing the adhesive contains at least one pressure tank that can be temporarily connected to the pressure tank by means of a changeover valve in order to apply a pressure pulse to the liquid container, and a control unit for controlling the changeover valve and regulating the pressure prevailing in the pressure tank. In accordance with the invention, the device is equipped with a sensor the output signal of which indicates the liquid level of the liquid container. The sensor comprises a sound transducer, a sound transformer and an electronic circuit for operation of the sound transducer and for analyzing the signal delivered by the sound transformer. The sensor measures the frequency of the alternating electrical signal applied to the sound transducer with which a standing sound wave occurs in the liquid container. The control unit adjusts either the level of the pressure prevailing in the pressure tank or the length of the pressure pulse subject to the output signal from the sensor.

### PRIORITY CLAIM

Applicant hereby claims foreign priority under 35 U.S.C §119 from Swiss Application No. 1236/05 filed Jul. 25, 2005, the disclosure of which is herein incorporated by reference.

### FIELD OF THE INVENTION

The invention concerns a device for applying adhesive to a substrate.

### BACKGROUND OF THE INVENTION

With the mounting of semiconductor chips, epoxy based adhesives are often used that contain flakes of silver. The adhesive is located in a syringe to which pressure pulses are applied from a pneumatic device in order to press out the adhesive in portions. Application of the adhesive is done either by means of a dispensing nozzle that has several openings through which the adhesive exudes and is deposited on the substrate, or by means of a writing nozzle that has one single opening through which the adhesive exudes. The writing nozzle is guided along a predetermined path by means of a drive system that can be moved in two horizontal directions so that the deposited adhesive forms a predetermined adhesive pattern on the substrate. A semiconductor mounting device with a writing nozzle that can be moved in two horizontal directions is known for example from EP 1432013. The syringe is arranged stationary and its outlet is connected to the movable writing nozzle via a tube. Delivery of the adhesive is done in that the pneumatic device produces a pressure pulse that lasts just as long as the writing movement of the writing nozzle. One disadvantage is that the amount of liquid delivered is dependent on the degree of emptying of the syringe. From the patent specifications U.S. Pat. No. 5,199,607 and U.S. Pat. No. 5,277,333, pneumatic devices are known that contain a pressure tank the pressure level of which is regulated by a pressure controller. In order to keep the delivered amount of liquid constant, the pressure prevailing in the line from the pressure tank to the syringe is measured and integrated during liquid delivery and the length of the pressure pulse varied until the integral of a predetermined set value is achieved. This solution impedes the co-ordination with the writing movement of the writing nozzle. From the patent application JP 04-200671 it is known to either adjust the pressure level or the length of the pressure pulse based on the number of pressure pulses delivered or the entire duration of the previously delivered pressure pulses. This solution is relatively inaccurate.

### SUMMARY OF THE INVENTION

An object of the invention is to develop a device for applying adhesive to a substrate with which the amount of adhesive delivered is as independent as possible from the degree of emptying of the syringe. In addition, the solution should be suitable for retrofitting to already existing devices.

A device for applying adhesive to a substrate from a liquid container containing the adhesive includes at least a pressure tank that is temporarily connected to the pressure tank by means of a valve, generally a changeover valve, in order to apply a pressure pulse to the liquid container, and a control unit for controlling the valve and regulating the pressure prevailing in the pressure tank. In accordance with the invention, the device is equipped with a sensor the output signal of which indicates the filling level of the adhesive in the liquid container. The sensor comprises a sound transducer, a sound transformer and an electronic circuit for operating the sound transducer and processing a signal delivered by the sound transformer or the sound transducer to form the output signal of the sensor. The sensor is attached detachably to the liquid container at the opposite end to the outlet. The sensor measures preferably the frequency of the alternating signal (voltage or current) applied to the sound transducer with which a standing sound wave occurs in the liquid container. The control unit that as said before regulates the pressure prevailing in the pressure tank adjusts either the level of the pressure prevailing in the pressure tank or the length of the pressure pulse subject to the output signal from the sensor, i.e., under consideration of the liquid level or the dead volume of the liquid container that corresponds to the amount of adhesive already dispensed from the liquid container. In principle, the control unit has to increase the pressure level with increasing degree of emptiness or dead volume of the liquid container.

Because of the light weight of the sensor and the low space requirement of the device, the device is particularly suitable for use with a writing head that can be moved in three spatial directions and comprises a writing nozzle, whereby the liquid container is detachably attached to the writing head and its outlet opens out into the writing nozzle. In this case, the control unit preferably controls the pressure prevailing in the pressure tank subject to the output signal from the sensor while the duration of the pressure pulse is not changed so that the duration of the writing movement does not have to be changed.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows a liquid container in the form of a syringe with a connection for the supply of compressed air and a sensor for measuring the liquid level of the syringe,

FIG. 2 shows an electronic circuit for operating the sensor,

FIG. 3 shows a device for applying adhesive, with which the syringe is arranged stationary,

FIG. 4 shows a device for applying adhesive with which the syringe is arranged on a movable writing head, and

FIG. 5 shows a pneumatic device for operating the syringe.

### DETAILED DESCRIPTION OF THE INVENTION

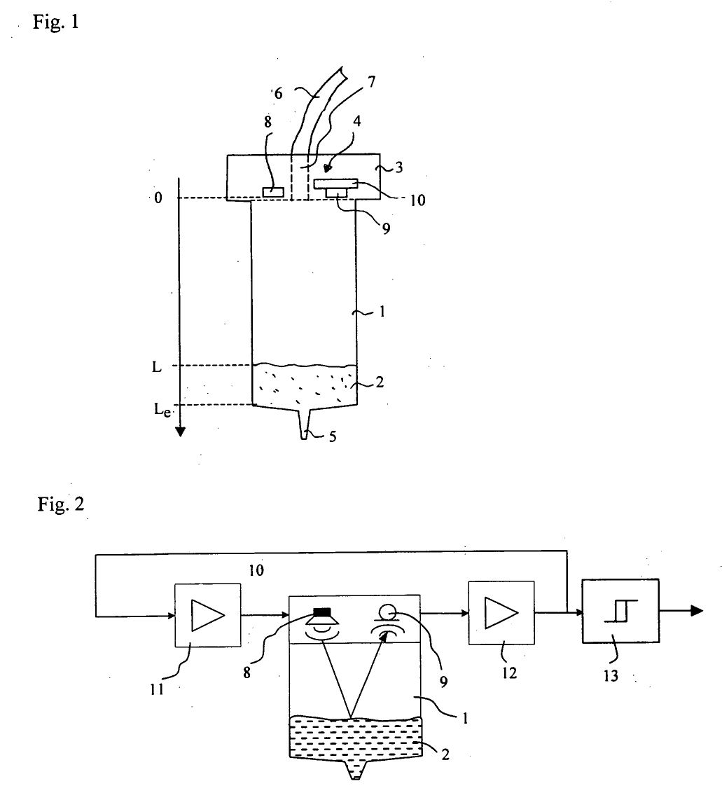

FIG. 1 shows a liquid container in the form of a syringe 1 that is used for example with semiconductor assembly devices known as Die Bonders for applying adhesive 2 to a substrate. A cover 3 is placed on the end of the syringe 1 that makes the syringe 1 airtight. A sensor 4 for detecting the liquid level in the syringe 1 is integrated into the cover 3. The adhesive 2 is preferably pressed out in portions through the tip 5 of the syringe 1 by means of compressed air. The compressed air is supplied via a tube 6 that is pushed over a pressure connection 7 integrated into the cover 3. Epoxies of all types can be used as adhesives 2, in particular epoxy resins containing silver powder or silver flakes.

The sensor 4 comprises a sound transducer 8, a sound transformer 9 and an electronic circuit 10 for operating the sound transducer 8 and for evaluation of the electrical signal delivered by the sound transformer 9. The sound transducer 8 is preferably a piezoelectric crystal to which an alternating electrical voltage is applied in order to deliver a sound wave. The sound transformer 9 is for example a microphone that transforms the acoustic signal into an electrical signal. The sound transducer 8 and the sound transformer 9 are preferably arranged next to each other at the same level. The electronic circuit 10 is either integrated into the cover 3 or mounted somewhere on the semiconductor assembly device.

The liquid level of the syringe 1 is characterised by a length L whereby the length L simultaneously corresponds to the distance between the level of the adhesive 2 and the level of the sound transducer 8 and the sound transformer 9. With increased emptying of the syringe 1, the length L increases. In the example, the length amounts to L=Lₑ=6 cm, when the syringe 1 is empty and has to be replaced.

The electronic circuit 10 delivers a preferably sinusoidal alternating voltage U₁ with a predetermined frequency f that is applied to the sound transducer 8. The sound transducer 8 delivers a sound wave that disperses in the syringe 1, is reflected by the adhesive 2 and impacts on the sound transformer 9. Under certain conditions, a standing sound wave is formed in the syringe 1 that has a node at the location of the sound transformer 9. The basic principle of the measurement comprises in detecting the occurrence of the standing sound wave. A standing sound wave occurs when the frequency f and the length L fulfil the equation

$$L = \frac{c}{4 f} \qquad ( 1 )$$

whereby the constant c designates the sound velocity of air. The constant c amounts to 355 m/s. Therefore, when the frequency f of the alternating voltage applied to the sound transducer 8 is selected at fₑ=1479 Hz, then, according to the equation (1), a standing sound wave occurs when the adhesive 2 reaches the liquid level assigned to the length Lₑ=6 cm. The output signal U₂(t) from the sound transformer 9 as a function of time t can be represented as a Fourier series:

$${U}_{2} ( t ) = {\sum }_{n = 1}^{∞} {A}_{n} sin ( 2 π * n * f * t + {φ}_{n} ) , \qquad ( 2 )$$

whereby the coefficients Aₙ designate the amplitude and the coefficients designate φₙ the phase of the corresponding oscillation. The oscillation with the frequency f is designated as the fundamental wave or fundamental oscillation, the oscillations with the frequencies n*f for n>1 are designated as harmonics.

The occurrence of the standing sound wave is manifested in the output signal U₂ of the sound transformer 9, in that the amplitude A₁ of the fundamental wave reaches a minimum and in that the amplitude A₂ of the first harmonic reaches a maximum with the frequency 2f.

For acquisition of the actual liquid level therefore the frequency f has to be determined with which a standing sound wave occurs. FIG. 2 shows a simple electronic circuit 10 the output signal of which is proportional to the liquid level, i.e., to the length L. The electronic circuit comprises an amplification stage with two amplifiers 11 and 12 arranged in series the amplification factor of which is very large. The output signal of the sound transformer 9 is amplified by the two amplifiers 11 and 12 and applied to the sound transducer 8. The acoustic feedback automatically has the effect that the frequency f of this closed control circuit adjusts itself so that a standing sound wave forms in the syringe 1. The signal at the output of the first amplifier 11 is fed to a Schmitt trigger component 13 that transforms the signal into a series of square-wave pulses that can be counted by a higher-level control device, e.g., by the control device of the device for applying adhesive. The pulses also have the frequency f.

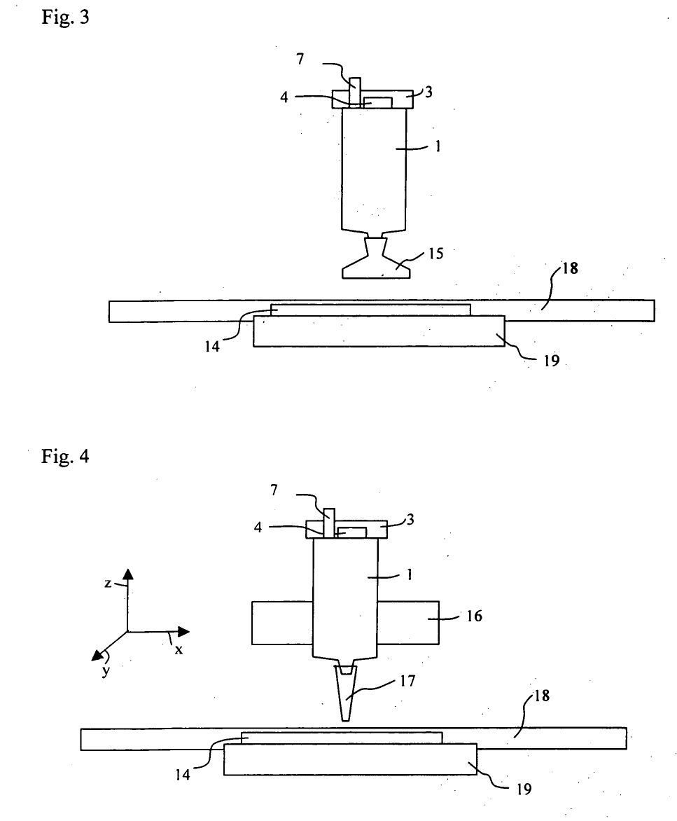

FIG. 3 shows a device for applying adhesive to a substrate 14 with which the liquid container is arranged stationary. The liquid container is a syringe 1 with one outlet to which a nozzle 15 with one or more openings is detachably attached.

FIG. 4 shows a device for applying adhesive to a substrate 14 with which the liquid container is arranged on a writing head 16 that can be moved in three Cartesian directions x, y and z whereby the outlet of the liquid container opens out into a detachably attached writing nozzle 17. Generally, the writing nozzle 17 contains only one single outlet.

The two devices are part of a dispensing station of a semiconductor assembly device known as a die bonder.

With both devices, the substrates 14 are transported by a transport system 18 to a support table 19 where the adhesive is applied and then further transported from the support table 19 to a bonding station of the semiconductor assembly device where a semiconductor chip is placed on the adhesive. During so-called holding phases, vacuum is applied to the syringe 1 in order to prevent adhesive from dripping out and during so-called application phases a pressure pulse is applied in order to deposit a portion of adhesive onto the substrate 14 presented on the support table 19.

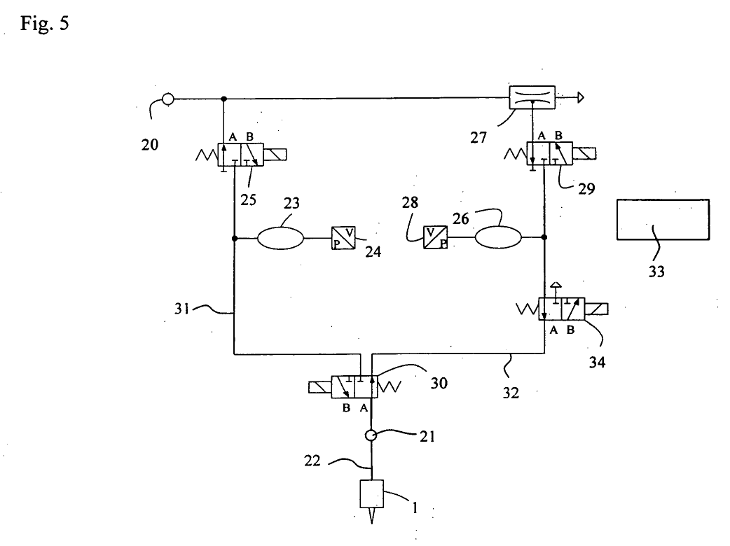

FIG. 5 shows an example of a pneumatic device that can be used for delivery of the adhesive with the devices in accordance with FIGS. 3 and 4. The pneumatic device contains an inlet 20 for the supply of compressed air that is produced by an external compressed air source, and an outlet 21 that can be connected to the pressure connection 7 (FIG. 3) of the syringe 1 via a first pressure line 22. The pneumatic device comprises a pressure tank 23 the pressure level of which is measured by a first pressure sensor 24 and adjusted by means of an inlet valve 25 via which the pressure tank 23 can be connected to the inlet 20. Furthermore, the pneumatic device comprises a vacuum tank 26 that is supplied with vacuum from a vacuum source 27 and the pressure level of which is measured by a second pressure sensor 28 and adjusted by means of an outlet valve 29 via which the vacuum tank 26 can be connected to the vacuum source 27. The vacuum source 27 is for example a venturi nozzle operated by compressed air.

In addition, the pneumatic device contains a changeover valve 30, a second pressure line 31 that connects the changeover valve 30 to the pressure tank 23, a third pressure line 32 that connects the changeover valve 30 to the vacuum tank 26. The changeover valve 30 has two positions at which the first pressure line 22 is connected either to the second pressure line 31 or to the third pressure line 32.

In order that the pressure prevailing in the syringe 1 can be more quickly reduced at the end of the pressure pulse and in order that in doing so there is less load on the vacuum tank 26, a second changeover valve 34 is preferably arranged in the third pressure line 32 between the changeover valve 30 and the vacuum tank 26 that each time temporarily connects the syringe 1 with the ambient air until the pressure has reduced to the level of the atmospheric pressure.

The output signal of the sensor 4 as well as the output signals of the pressure sensors 24 and 28 are fed to a control unit 33. The control unit 33 controls all valves 25, 29, 30 and if necessary 34. According to a preferred operating method, at the start of the holding phase the pressure tank 23 is connected to the inlet 20 in terms of pressure until the pressure in the pressure tank 23 has reached the value calculated by the control unit 33 depending on the liquid level of the syringe 1. During the application phase the pressure tank 23 preferably remains separated from the inlet 20. Likewise, at the start of the application phase, the vacuum tank 26 is connected to the vacuum source 27 in terms of pressure until the vacuum in the vacuum tank 26 has reached the stipulated set value.

During operation, the changeover valve 30 is switched back and forth between its two positions so that the syringe 1 is connected to the vacuum tank 26 during the holding phases and to the pressure tank 23 during the application phases. During the holding phases, the sensor 4 measures the liquid level L in the syringe 1. The dead volume V_{T}, that corresponds to the volume of the syringe 1 emptied of adhesive, results for a cylindrical syringe with an inner radius r as
V_{T}=π*r²*L (3)

With the device in accordance with FIG. 3 the pressure level of the pressure prevailing in the pressure tank 23 and/or the duration of the application phase is increased subject to the measured liquid level L or the dead volume V_{T} of the syringe 1 in order to keep the delivered amount of adhesive constant despite the emptying of the syringe 1.

With the device in accordance with FIG. 4 preferably only the pressure level of the pressure prevailing in the pressure tank 23 is increased depending on the measured liquid level L or the dead volume V_{T} of the syringe 1 in order to keep the amount of adhesive delivered constant despite emptying the syringe 1 while the duration of the application phase remains unchanged. Then, the duration of the writing movement of the writing nozzle 17 does not have to be changed.

The degree by which the pressure level of the pressure prevailing in the pressure tank 23, or if necessary the duration of the application phase, has to be increased is dependent on the actual properties of the entire system and has to be determined experimentally.

The device for applying adhesive is preferably set up to trigger an alarm and/or to stop the semiconductor assembly device as soon as the syringe 1 is empty, i.e., as soon as the liquid level has reached the value Lₑ.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A device for applying adhesive to a substrate, comprising
a liquid container containing the adhesive and having an outlet,
a pressure tank,
a valve for temporarily connecting the pressure tank to the liquid container in order to apply a pressure pulse to the liquid container,
a sensor comprising a sound transducer and a sound transformer, wherein the sensor is detachably attached to an end of the liquid container opposite to the outlet,
an electronic circuit for operating the sound transducer and forming an output signal of the sensor indicating a filling level of the adhesive in the liquid container, and
a control unit for controlling the pressure prevailing in the pressure tank and the valve, wherein the control unit adjusts a level of the pressure prevailing in the pressure tank and/or a length of the pressure pulse subject to the output signal from the sensor.

2. The device according to claim 1, further comprising a writing head with a writing nozzle, wherein the writing head is movable in three spatial directions, wherein the liquid container is detachably mounted on the writing head so that the outlet of the liquid container opens out into the writing nozzle, and wherein the control unit only adjusts the level of the pressure prevailing in the pressure tank subject to the output signal from the sensor.

3. The device according to claim 1, wherein the output signal of the sensor represents a frequency of an AC signal applied to the sound transducer with which standing sound waves occur in the liquid container.

4. The device according to claim 2, wherein the output signal of the sensor represents a frequency of an AC signal applied to the sound transducer with which standing sound waves occur in the liquid container.

5. The device according to claim 1, adapted to trigger an alarm when the level of the adhesive in the liquid container has reached a predetermined level.

6. The device according to claim 2, adapted to trigger an alarm when the level of the adhesive in the liquid container has reached a predetermined level.

7. The device according to claim 3, adapted to trigger an alarm when the level of the adhesive in the liquid container has reached a predetermined level.

8. The device according to claim 4, adapted to trigger an alarm when the level of the adhesive in the liquid container has reached a predetermined level.
